(19) United States
(12) Patent Application Publication
(10) Pub. No.: US 2007/0184143 A1
(43) Pub. Date: Aug. 9, 2007

(54) Tablet press machine

(76) Inventors: Fabriano Ferrini, Medicina (Bologna) (IT); Roberto Trebbi, Castenaso (Bologna) (IT)

Correspondence Address: ARENT FOX PLLC, 1050 CONNECTICUT AVENUE, N.W., SUITE 400, WASHINGTON, DC, 20036, US

(21) Appl. No.: 11/578,969

(22) PCT Filed: Feb. 2, 2006
(86) PCT No.: PCT/IB06/00271

§ 371 Date: Oct. 18, 2006

(30) Foreign Application Priority Data
Mar. 1, 2005 (IT) BO2005A 000111

(51) Int. Cl. B30B 11/08

(52) U.S. Cl. 425/193; 425/182; 425/345; 425/225; 425/411

(57) ABSTRACT

A tablet press machine (1) comprises a covering structure (100) enclosing in a delimited space a rotary turret (T) for the production of tablets (C); hopper means (2) for containing pharmaceutical material (M) in powder or granular form to be pressed; rotary disc means (3, 5, 6) equipped with matrices (4) designed to contain defined quantities or doses of the pharmaceutical material (M) fed to them by the hopper means (2); reciprocating punch means (7; 7a, 7b) for compressing the doses inside the matrices (4); at least a first and a second station (Z1, Z2) for completing the tablets (C) formed in respective first and second forming lines (A1, A2); the first and second completing stations (Z1, Z2) are positioned at a defined angular interval from each other on the turret (T); the machine (1) further comprises a single outfeed station (Z3) outside the structure (100) where the tablets (C) are made by the first and second forming lines (A1, A2); and conveyor means (8) coupled with the turret (T) and defining a channel for feeding the tablets (C) formed in the first line (A1) and completed in the first completing station (Z1) to the outfeed station (Z3) along a path (P) running parallel to and alongside the second line (A2).

### TECHNICAL FIELD

The present invention relates to a tablet press machine.

In particular, the invention relates to a tablet press machine for the production of tablets used preferably in the pharmaceutical field to which this specification refers but without thereby restricting the scope of the invention.

### BACKGROUND ART

Usually, a tablet press machine for manufacturing tablets comprises a cover structure housing a feed hopper for feeding material in powder or granular form to a turret unit which in turn comprises a first rotary disc having uniformly distributed round its edge a plurality of seats or matrices designed to form a tablet from the defined volumetric quantity or dose of pharmaceutical material inside each seat or matrix.

The tablets are formed by reciprocating punches also uniformly distributed around two further discs that rotate about the same axis as, and in synchrony with, the first disc with the matrices on it, these two further discs being located above and below the first disc. The two punches in each pair—one above and one below—access a specific matrix simultaneously and compress the dose of material inside the matrix with a predetermined (increasing) force for each successive matrix as the discs rotate and until the pressure suitable for forming a tablet is reached.

The tablet press machine described above therefore has a precise angular position where the powdered or granular material is loaded into the forming seats or matrices; another position another position, close to the preceding one, where the formed tablets are fed out towards an outfeed chute: In practice, the tablet is completely formed in one full rotation of approximately 360° of the matrix discs.

Recent technological developments and the demand for higher output machines in the pharmaceutical industry have led to the creation of tablet presses that can perform a double production cycle, that is to say, having two diametrically opposite areas for initial loading of the powdered or granular material and two corresponding areas for feeding out the tablets.

From a conceptual viewpoint, in order to double machine output, the process cycle has been altered in such a way that a single tablet can be made by the discs rotating through an angular interval of 180°, instead of 360° as previously, giving new tablet presses a greater production potential and a higher degree of flexibility than older generation tablet presses.

A tablet press that embodies this conceptual solution is described and protected by the same Applicant as the present invention in international patent application WO 2004/007185, where the complete tablet forming cycle is double and takes place simultaneously on two forming lines on two distinct arcs or sectors of the first disc, within respective angular intervals and defining two end-of-cycle areas.

These two areas comprise a first and a second tablet outfeed station, separate from each other and located at the respective areas where the simultaneous tablet forming cycles end on the distinct sectors of the first disc.

At the two tablet outfeed stations, where the finished tablets are expelled from the covering structure, the tablet press described above has respective tablet conveyor belts extending outside the covering structure.. The conveyors merge at a common area, also outside the machine, so as to permit and facilitate subsequent inspection and storage of the tablets.

This solution, although it greatly increases the productivity of the machine, has led to a serious drawback due to the fact that the tablets fed out of the machine on the conveyor belts are in contact with the outside environment, unprotected, and thus exposed to the risk of contamination.

Moreover, the external conveyors occupy a great deal of space around the tablet press.

### DISCLOSURE OF THE INVENTION

The present invention has for an aim to provide a tablet press machine that is free of the above mentioned disadvantages.

Accordingly, the present invention provides a tablet press machine of the type comprising a covering structure enclosing in a delimited space a rotary turret for the production of tablets; hopper means for containing pharmaceutical material in powder or granular form to be pressed; rotary disc means equipped with matrices designed to contain defined quantities or doses of the pharmaceutical material fed to them by the hopper means; reciprocating punch means for compressing the doses inside the matrices; at least a first and a second station for completing the tablets formed in respective first and second forming lines on the turret; the first and second completing stations being at a defined angular interval from each other on the turret; the machine being characterised in that it comprises a single outfeed station outside the structure where the tablets are made by the first and second forming lines; and conveyor means coupled with the turret and adapted to define a channel for feeding the tablets formed in the first line and completed in the first completing station to the outfeed station along a path running alongside the second line.

### BRIEF DESCRIPTION OF THE DRAWINGS

The technical characteristics of the invention are clearly described in the claims below and its advantages are apparent from the detailed description which follows, with reference to the accompanying drawings which illustrate a preferred embodiment of the invention provided merely by way of example without restricting the scope of the inventive concept, and in which:

FIG. 1 is a schematic perspective view of a preferred embodiment of the tablet press machine according to the present invention;

FIG. 2 is a plan view, partly in cross section and with some parts cut away for clarity, of the tablet press machine of FIG. 1; and

FIG. 3 is a vertical plane section along III-III of a part of the tablet press machine illustrated in FIG. 2.

### DETAILED DESCRIPTION OF THE PREFERRED EMBODIMENTS OF THE INVENTION

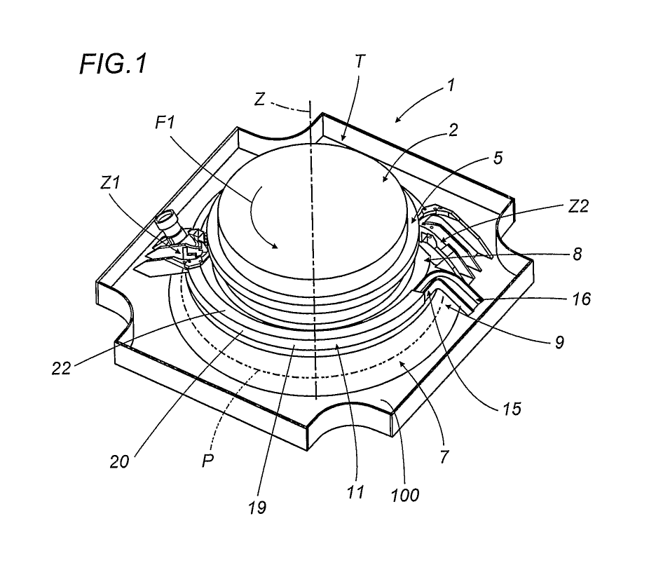

With reference to FIGS. 1, 2 and 3, the numeral 1 denotes in its entirety a tablet press machine used for making tablets C, especially, but not restricted to, tablets C for pharmaceutical use.

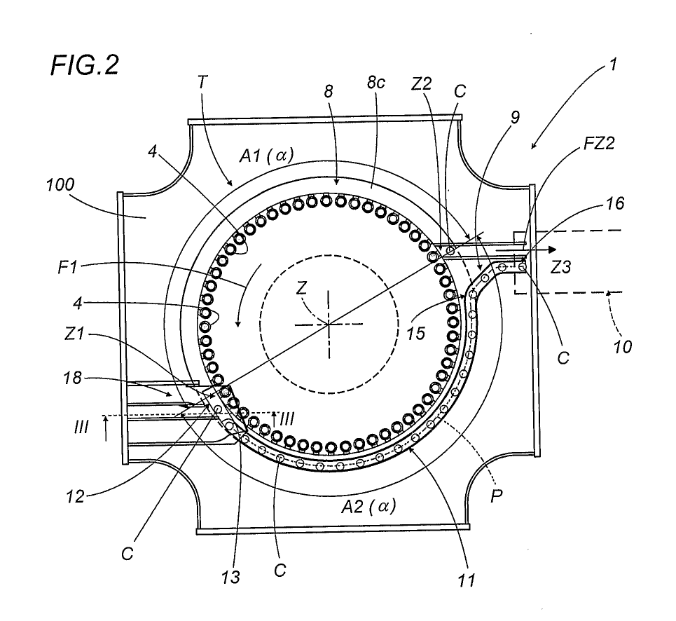

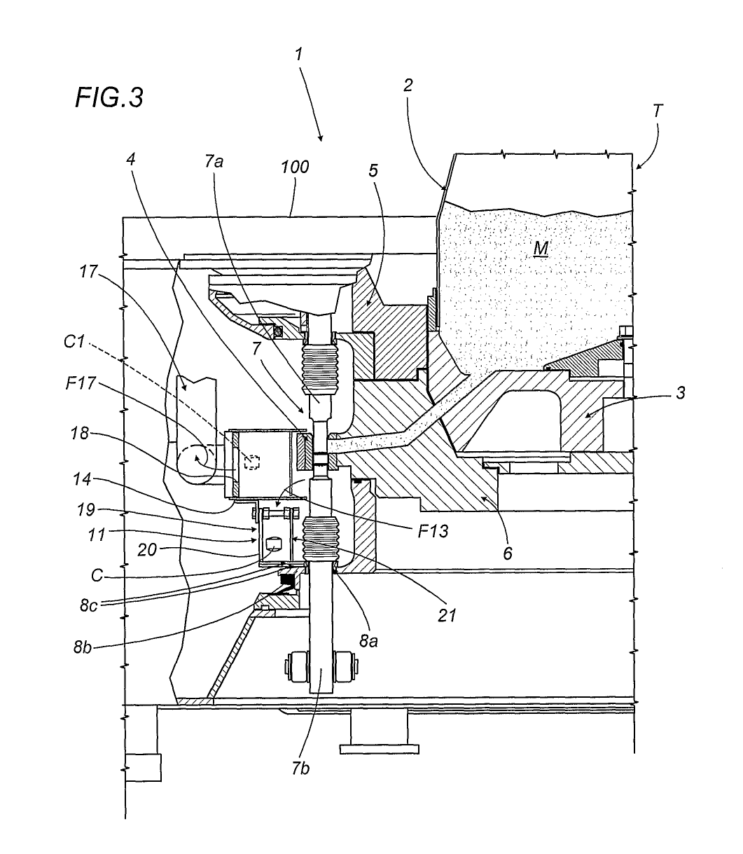

The machine 1 is of the type essentially comprising a sealed covering structure 100 having the general shape of a parallelepiped (partially illustrated in FIG. 3, and a base or bottom surface of which is illustrated in FIGS. 1 and 2) which encloses in a delimited space forming a protected environment a hopper 2, a rotary turret T, a pair of disc elements 5 and 6 mounting pairs of opposed reciprocating punches 7; a first and a second station Z1 and Z2 for completing the tablets C; and a single station Z3 for feeding the tablets C out of the tablet press machine 1, that is to say, for expelling them from the structure 100; the station Z3 in turn comprises a single unit 10 for storing the tablets C completed in the machine 1 stations Z1 and Z2.

More specifically, the hopper 2 is designed to contain the pharmaceutical material M in powder or granular form to be fed to the turret T and is mounted centrally on the turret T to provide a centrifugal feed system for the turret T (as illustrated in FIG. 3); or (in an embodiment that is not illustrated), the hopper 2 may be mounted on one side of the turret T to provide a conventional feed system for the turret T.

The turret T consists of a disc element 3 that rotates about a vertical axis Z (in an anticlockwise direction F1 in FIGS. 1 and 2), and is equipped with seats or matrices 4 uniformly distributed round its edge.

The above mentioned disc elements 5 and 6 are coupled with the first disc element 3, located respectively above and below the element 3, and rotate in synchrony with the element 3 itself about the same vertical axis Z.

Further, the disc elements 5 and 6 have mounted on them respective pluralities of punches 7—that is, more specifically, upper punches 7a mounted on the disc element 5 opposite lower punches 7b (FIG. 3) mounted on the disc element 6—which are reciprocatingly mobile towards and away from the matrices 4 and designed to gradually compress the powdered material M fed by the hopper 2 in order to make the tablets C simultaneously on two tablet C forming lines A1 and A2.

Each of the two forming lines A1 and A2 extends around a semicircular sector of the disc 3 around the axis Z and defined by an angle of rotation α of approximately 180° of the disc element 3 about the axis Z, and end with the above mentioned tablet C completing stations Z1 and Z2 which are thus located diametrically opposite each other on the turret T.

As clearly illustrated in FIGS. 2 and 3, the turret T with the disc elements 3, 5 and 6 mounts a fixed annular supporting element 8 that rotates with the turret T itself about the axis Z and is designed to receive and support the tablets C formed in the line A1 and expelled from the respective matrices 4 at the station Z1 and to feed them along an adjacent semicircular path P parallel to and running alongside and on the outside of the line A2 to reach the outfeed station Z3 at the same time as the tablets C formed in the line A2 and expelled from the respective matrices 4 at the station Z2.

More specifically, the annular supporting element 8 is defined by a circular, ring-like plate 8c mounted by the disc 6 through sealed flanges 8a (FIG. 3), surrounding the lower punches 7b on the disc 6 itself and attached to a circular base 8b protruding radially from the disc 6 and positioned under and in contact with the circular ring-like plate 8c itself: thus, the ring-like plate 8c rotates about the vertical axis Z in synchrony with the discs 3, 5 and 6 and transports the equally spaced tablets C made on the first line A1 towards the outfeed station Z3 where the tablets made on the second line A2 are fed out of the completing station Z2.

Along the annular supporting element 8 there are also sealed covering means 11 mounted fixedly at least along the tablet C feed path P.

As illustrated in FIG. 3, these covering means 11 preferably comprise an arc-shaped guard 19 shaped to match the annular portion of the path P and defined by a pair of vertical side walls 20 and 21 and a horizontal wall 22 (FIG. 1) parallel to the annular element 8 to form a closed transporting channel together with the annular element 8 itself.

The numeral 9 denotes directing and guiding means located at least along a section of the annular element 8 in the vicinity of the outfeed station Z3: the purpose of the guiding means 9 is to divert the tablets C from the semicircular path P and to guide them into the storage unit 10.

As illustrated in FIGS. 1 and 2, the guiding means 9 comprise a tablet C deflector element 15 associated with the ring-like plate 8c and with the covering means 11 and enabling the tablets C to be guided towards a first chute 16 which is in turn associated (or made as single part) with the deflector 15 leading into the storage unit 10.

The storage unit 10 is of known type and therefore illustrated schematically in FIG. 2 in dashed line style: it comprises preferably, but not necessarily, a belt or similar type of conveyor designed to transport the tablets C to inspection and packaging stations (of known type and not illustrated) located further downstream.

The tablet press machine 1 also comprises second conveyor or guide means 12 consisting of a second chute 13 for guiding the tablets C towards the annular support 8.

As illustrated in FIGS. 2 and 3, the second chute 13 is associated with a fixed support 14 in the vicinity of the turret T, facing one of the above mentioned seats or matrices 4, and is designed to feed out the tablets C made in the first line A1, guiding them as they fall towards the annular support 8 (arrow F13, FIG. 3).

The second chute 13 is rigidly connected to the guard 19 and, together with the deflector element 15 and the first chute 16, forms a single structure rigidly connected and fixed with respect to the rotary discs 3, 5 and 6 and the annular supporting element 8.

As shown in FIG. 2, the first completing station Z1 that uses the annular supporting element 8 also comprises an auxiliary pickup area, labelled 18, defined by a pickup portion of the second chute 13.

A certain number of the tablets C are picked up by suction means 17 as sample tablets to be inspected (labelled C1 in FIG. 3) or as defective tablets to be rejected when they are expelled from the seat 4 of the turret T (arrow F17, FIG. 3).

For this purpose, the auxiliary pickup area 18 comprises a chamber 18 (FIGS. 2 and 3), located to one side of the outfeed seat or matrix 4 on the turret T and associated with a pipe 17 that applies suction for conveying the sample tablets C1 or the defective tablets to respective collection units (of known type and not illustrated).

The tablet press machine 1 described above works in the following manner.

The powder or granular material M is compressed simultaneously along two lines A1 and A2 of the turret T which rotates in direction F1.

The formed tablets C are expelled from the matrices 4 at the respective stations Z1 and Z2.

In particular, at the station Z1, the tablets that were formed in the line A1, are expelled onto the second chute 13 which conveys the tablets C themselves to the closed channel defined by the ring-like plate 8c and the covering means 11 coupled with it.

The plate 8c, rotating as one with the turret T, transports the tablets C from the line A1 in substantially ordered fashion along the path P parallel to and running simultaneously alongside the line A2 as far as the point where the tablets C formed in the line A1 meet the deflector 15 which diverts them onto the first chute 16.

The chute 16 enables the tablets C of line A1 to leave the machine 1 and to drop into the storage unit 10 of the station Z3 at the same time as the tablets C formed in the line A2 and completed at the station Z2 drop into the same storage unit 10 of the station Z3 (arrow FZ2, FIG. 2).

A tablet press structured as described above therefore fully achieves the aforementioned aims thanks to a sealed tablet conveying system built into the machine turret.

Those in the trade will appreciate the advantages of the machine 1 due, in particular, to the reduced size of the structure around the outside of the machine 1 and, consequently, elimination of the costs that would otherwise be necessary for two independent outfeed stations; but above all due to the provision of a system for feeding and transporting the tablets C that is always in a protected environment defined by the covering structure 100 of the machine 1 and using the turret T itself to convey all the tablets C to the outfeed station Z3, thus eliminating undesirable handling of the tablets C outside the protected environment.

The above is achieved without reducing the productivity of the machine 1 with two tablet C completing stations Z1 and Z2.

It will be understood that the invention as described herein can be modified and adapted in several ways without thereby departing from the scope of the inventive concept. Moreover, all the details may be substituted by technically equivalent elements.

1. A tablet press machine (1) of the type comprising a covering structure (100) enclosing in a delimited space a rotary turret (T) for the production of tablets (C); hopper means (2) for containing pharmaceutical material (M) in powder or granular form to be pressed; rotary disc means (3, 5, 6) equipped with matrices (4) designed to contain defined quantities or doses of the pharmaceutical material (M) fed to them by the hopper means (2); reciprocating punch means (7; 7a, 7b) for compressing the doses inside the matrices (4); at least a first and a second station (Z1, Z2) for completing the tablets (C) formed in respective first and second forming lines (A1, A2) on the turret (T); the first and second completing stations (Z1, Z2) being positioned at a defined angular interval from each other on the turret (T); the machine (1) being characterised in that it further comprises a single outfeed station (Z3) outside the structure (100) where the tablets (C) are made by the first and second forming lines (A1, A2); and conveyor means (8) coupled with the turret (T) and defining a closed channel for feeding the tablets (C) formed in the first line (A1) and completed in the first completing station (Z1) to the outfeed station (Z3) along a path (P) running alongside the second line (A2).

2. A tablet press machine according to claim 1, characterised in that the conveyor means (8) comprise a plate type annular element (8c) fixedly coupled with one (6) of the rotary disc means (3, 5, 6); and means (11) for covering the element (8c) to define the closed channel for feeding the tablets (C) along the path (P).

3. The machine according to claim 2, characterised in that the element (8c) is coupled with the disc means (6) through flanges (8a) attached to a circular base (8b) protruding radially from the disc means (3).

4. The tablet press machine according to claim 2 or 3, characterised in that the covering means (11) comprise an arc-shaped guard (19) having at least one pair of vertical side walls (20, 21) and a horizontal wall (22) parallel to the annular element (8c).

5. The machine according to any one of claims 2 or 3, characterised in that, at the outfeed station Z3, the closed channel for feeding the tablets (C) also comprises means (9) for guiding the tablets (C) towards the outfeed station (Z3); said guiding means (9) being defined by a tablet (C) deflector element (15), associated with the conveying means (8, 11) and designed to divert the tablets (C) from the path (P) and re-direct them towards a chute (16) associated with the deflector (15) and leading into the external storage unit (10).

6. The machine according to claim 2, characterised in that it further comprises means (12) for guiding the tablets (C) fed out from the first completing station (Z1) and defined by a chute (13) for conveying the tablets (C) downwards to the annular element (8c).

7. The machine according to any one of claims from 1, 2, or 3, characterised in that the first station (Z1) further comprises an area (18) for picking up reject or sample tablets (C1); the pickup area being provided with suction means (17) for picking up the defective or sample tablets (C1).

8. The machine according to claim 4, characterised in that, at the outfeed station Z3, the closed channel for feeding the tablets (C) also comprises means (9) for guiding the tablets (C) towards the outfeed station (Z3); said guiding means (9) being defined by a tablet (C) deflector element (15), associated with the conveying means (8, 11) and designed to divert the tablets (C) from the path (P) and re-direct them towards a chute (16) associated with the deflector (15) and leading into the external storage unit (10).

9. The machine according to claim 4, characterised in that the first station (Z1) further comprises an area (18) for picking up reject or sample tablets (C1); the pickup area being provided with suction means (17) for picking up the defective or sample tablets (C1).

10. The machine according to claim 5, characterised in that the first station (Z1) further comprises an area (18) for picking up reject or sample tablets (C1); the pickup area being provided with suction means (17) for picking up the defective or sample tablets (C1).

11. The machine according to claim 6, characterised in that the first station (Z1) further comprises an area (18) for picking up reject or sample tablets (C1); the pickup area being provided with suction means (17) for picking up the defective or sample tablets (C1).
